(19) United States
(12) Patent Application Publication
(10) Pub. No.: US 2020/0024191 A1
(43) Pub. Date: Jan. 23, 2020

(54) SILOXANE POLYMERIZATION IN GYPSUM WALLBOARD

(71) Applicant: UNITED STATES GYPSUM COMPANY, Chicago, IL (US)

(72) Inventors: Qinghua LI, Rolling Meadows, IL (US); Mark K. HEMPHILL, Hawthorn Woods, IL (US); Trevor S. RISCHE, Trevor, WI (US)

(73) Assignee: UNITED STATES GYPSUM COMPANY, CHICAGO, IL (US)

(21) Appl. No.: 16/401,658

(22) Filed: May 2, 2019

Related U.S. Application Data
(60) Provisional application No. 62/700,935, filed on Jul. 20, 2018.

(51) Int. Cl. C04B 11/00; C04B 26/10; C08L 83/04; C08K 5/17; B01J 21/10

(52) U.S. Cl. CPC C04B 11/005; C04B 26/10; C04B 2111/00629; C08K 5/17; B01J 21/10; C08L 83/04

(57) ABSTRACT

A method of making a gypsum board including: preparing an aqueous slurry including a mixture of: calcium sulfate hemihydrate, water at a weight ratio of water to calcium sulfate hemihydrate of 0.2:1 to 1.2:1, and on a dry basis per 100 parts by weight (pbw) calcium sulfate hemihydrate: 0.2 to 2 pbw siloxane, 0.01 to 2 pbw siloxane polymerization catalyst including magnesium oxide and optionally fly ash, and 0.01 to 0.2 pbw triethanolamine (TEOA); allowing the siloxane to polymerize to polysiloxane; and depositing the slurry on a first cover sheet and covering the slurry with a second cover sheet to shape the slurry, and allowing the shaped slurry to set to form the gypsum board. Also, disclosed is the gypsum board resulting from the method.

### CROSS-REFERENCE TO RELATED APPLICATION

This claims the benefit of U.S. provisional patent application No. 62/700,935, filed Jul. 20, 2018, incorporate herein by reference in its entirety.

### FIELD OF THE INVENTION

The present invention broadly contemplates improving the water resistance of gypsum boards, typically gypsum wallboards, by using production methods that include in situ polymerization of siloxanes in the gypsum slurry in the presence of triethanolamine (TEOA).

### BACKGROUND OF THE INVENTION

Gypsum is a naturally occurring mineral that is typically found in old salt-lake beds, volcanic deposits, and clay beds. In chemical terms, gypsum is calcium sulfate dihydrate (CaSO₄.2H₂O). This material is produced also as a by-product in various industrial processes. Gypsum is also known as calcium sulfate dihydrate, terra alba or landplaster.

Plaster of Paris is also known as calcined gypsum, stucco, calcium sulfate semihydrate, calcium sulfate half-hydrate or calcium sulfate hemihydrate. Synthetic gypsum, which is a byproduct of flue gas desulfurization processes from power plants, may also be used. When it is mined, raw gypsum is generally found in the dihydrate form. In this form, there are approximately two water molecules of water associated with each molecule of calcium sulfate.

When calcium sulfate dihydrate is heated sufficiently, in a process called calcining, the water of hydration is driven off and there can be formed either calcium sulfate hemihydrate (CaSO₄.½H₂O) (typically provided in the material commonly referred to as “stucco”) or calcium sulfate anhydrite (CaSO₄) depending on the temperature and duration of exposure. As used herein, the terms “stucco” and “calcined gypsum” refer to both the hemihydrate and anhydrite forms of calcium sulfate that may be contained therein. In order to produce the hemihydrate form, the gypsum can be calcined to drive off some of the water of hydration by the following equation:

CaSO₄.2H₂O→CaSO₄.½H₂O+3/2H₂O

Calcined gypsum is capable of reacting with water to form calcium sulfate dihydrate, which is a rigid product and is referred to herein as “set gypsum.”

A number of useful gypsum products can be made by mixing the stucco with water and permitting it to set by allowing the calcium sulfate hemihydrate to react with water to convert the hemihydrate into a matrix of interlocking calcium sulfate dihydrate crystals. As the matrix forms, the product slurry becomes firm and holds a desired shape. Excess water must then be removed from the product by drying.

In the absence of additives to prevent it, set gypsum absorbs up to 50% of its weight when immersed in water. Boards or panels that absorb water swell, become deformed and lose strength. This property is undesirable in products that are likely to be exposed to water. In areas such as bathrooms or kitchens, high temperature and humidity are common, and walls are likely to be splashed. In such areas, it is preferable to use a gypsum board that exhibits water resistance, thus maintaining strength and dimensional stability.

Many attempts have been made to improve the water resistance of gypsum products. Various hydrocarbons, including wax, resins and asphalt have been added to the slurry in order to impart water resistance to the set product. The use of siloxanes, which form silicone resins in gypsum products, to impart water resistance is well known. An example of a common gypsum product is gypsum board, which is widely used as a structural building panel. Speaking generally, gypsum board comprises a core made from an aqueous slurry of calcined gypsum which hydrates to form set gypsum. Typically, the board has a paper sheet lining adhered to both of its faces.

A characteristic of set gypsum is that it has a tendency to absorb water. To illustrate, a gypsum core containing no water-resistant additives can absorb as much as 40 wt % to 50 wt % water when immersed therein at a temperature of 70° F. for about two hours. In applications where the gypsum product is exposed to water or high humidity (e.g., as tile-backing in bathrooms and kitchens or as sheathings at exterior portions of a building), this characteristic is undesirable. The absorption of water by the gypsum tends to reduce the strength of the product, render the product vulnerable to microbiological growth, and to cause the facings to delaminate.

U.S. Pat. No. 8,133,600 of Wang, et al discloses polymerization of siloxane is improved using a gypsum-based slurry that includes stucco, Class C fly ash, magnesium oxide and an emulsion of siloxane and water. This slurry is used in a method of making water-resistant gypsum articles that includes making an emulsion of siloxane and water, then combining the slurry with a dry mixture of stucco, magnesium oxide and Class C fly ash. The slurry is then shaped as desired and the stucco is allowed to set and the siloxane polymerizes. The resulting product is useful for making a water-resistant gypsum panel having a core that includes interwoven matrices of calcium sulfate dihydrate crystals and a silicone resin, where the interwoven matrices have dispersed throughout them a catalyst comprising magnesium oxide and components from a Class C fly ash.

U.S. Patent App. Pub. No. 2015/0306846 of Xu et al. discloses an improved water-resistant gypsum product prepared with a high-viscosity siloxane where various accelerators (also referred to as catalysts in the art) can be added to initiate polymerization of siloxane in a gypsum product. In this instance, the high-viscosity siloxane in the aqueous slurry used to from the gypsum core can increase the slurry viscosity significantly and make production difficult.

U.S. Patent App. Pub. No. 2016/0258157 of Yu et al. and similarly U.S. Pat. No. 7,892,472 of Veeramasuneni et al. disclose gypsum panels with improved water resistance. In this instance, a polymerizable siloxane is added to the slurry used to make the gypsum product. Preferably, the siloxane is added in the form of an emulsion. A catalyst like magnesium oxide (MgO) is also included to speed polymerization of the siloxanes. However, the polymerization of the siloxane can be incomplete and result in additional drying time being needed to allow for more complete polymerization.

Thus there is a need in the art for improved gypsum boards and methods of producing gypsum articles with improved water-resistance at reasonable cost.

### SUMMARY OF THE INVENTION

The invention relates generally to gypsum wallboards produced by methods that include in situ polymerization of siloxanes in the presence of TEOA.

The invention provides a method of making a gypsum board comprising:

preparing an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate:
   0.2 to 2 pbw siloxane,
   0.01 to 2 pbw siloxane polymerization catalyst comprising magnesium oxide and optionally fly ash,
   0.01 to 0.2 pbw triethanolamine (TEOA);
allowing the siloxane to polymerize to polysiloxane; and
depositing the slurry on a first cover sheet and covering the slurry with a second cover sheet to shape the slurry, and
allowing the shaped slurry to set to form a set gypsum board.

The invention also provides a gypsum board comprising:

a core layer in the form of a panel, a first cover sheet and a second cover sheet, wherein the core layer is between a first cover sheet and a second cover sheet,

wherein the core layer resulted from setting, between the first cover sheet and the second cover sheet, an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate:
   0.2 to 2 pbw siloxane,
   0.01 to 2 pbw siloxane polymerization catalyst comprising magnesium oxide and optionally fly ash,
   0.01 to 0.2 pbw triethanolamine (TEOA);

in which the siloxane was allowed to polymerize to polysiloxane.

In other words the core layer is the solid layer of set aqueous slurry.

Other advantages, benefits and aspects of the invention are discussed below, and illustrated in the accompanying figures, and will be understood by those of skill in the art from the more detailed disclosure below. All percentages, ratios, proportions, and average molecular weights herein are by weight, unless otherwise specified.

As used in the present specification at the very least, and not as an attempt to limit the application of the doctrine of equivalents to the scope of the claim, each numerical parameter modified by the term “about” should at least be construed in light of the number of reported significant digits and by applying ordinary rounding techniques. For purposes of this disclosure a dry basis is a water free basis.

### BRIEF DESCRIPTION OF THE DRAWINGS

FIG. 1 is an example of the structure of a wallboard of the present invention.

FIG. 2 is another example of the structure of a wallboard of the present invention.

### DETAILED DESCRIPTION OF THE INVENTION

All average molecular weights, percentages and ratios used herein, are by weight (i.e., wt %) unless otherwise indicated.

The invention relates generally to gypsum wallboards produced by methods that include in situ polymerization of siloxanes in the presence of TEOA. More specifically, the slurry used for producing gypsum wallboard comprises calcium sulfate hemihydrate (provided in the material known herein as “stucco” or “calcined gypsum”), a siloxane emulsion, a catalyst (e.g., magnesium oxide), TEOA, and water. Optional other components in the AQUEOUS slurry include, but are not limited to, fly ash (preferably Class C fly ash), pregelatinized starch, accelerators, retarders, paper or glass fibers, dehydration inhibitors, binders, adhesives, dispersing aids, leveling or non-leveling agents, thickeners, bactericides, fungicides, pH adjusters, colorants, fillers, and mixtures thereof. The resultant gypsum wallboard comprises calcium sulfate dihydrate, silicone resin, a catalyst, TEOA, and optionally other components.

Wallboards produced from slurries comprising TEOA may advantageously have a reduced water absorption as compared to wallboards produced with comparable slurries without TEOA.

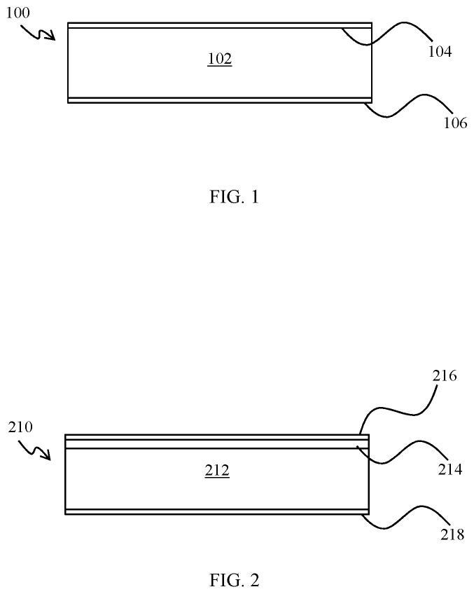

FIG. 1 is an example of the structure of a wallboard 100 of the present invention. The wallboard 100 includes a gypsum core 102 produced from a slurry formulation according to TABLE 1. The gypsum core 102 is sandwiched between two facings 104, 106. In TABLE 1 and elsewhere in the present disclosure the term “dry basis” means a water free basis.

TABLE 1
Aqueous Gypsum Core Slurry Formulation

| | | | More | Most |
|---|---|---|---|---|
| | Useable | Preferred | Preferred | Preferred |
| Component | Range | Range | Range | Range |
| calcium sulfate | 100 | 100 | 100 | 100 |
| hemihydrate (parts | | | | |
| by weight “pbw” | | | | |
| on a dry basis) | | | | |
| Siloxane (pbw on a | 0.2 to | 0.25 to | 0.3 to | 0.4 to |
| dry basis per 100 pbw | 2 | 1.5 | 1.2 | 1.0 |
| calcium sulfate | | | | |
| hemihydrate) | | | | |
| Catalyst (pbw on a | 0.01 to | 0.05 to | 0.1 to | 0.15 to |
| dry basis per 100 pbw | 2 | 1 | 0.8 | 0.4 |
| calcium sulfate | | | | |
| hemihydrate) | | | | |
| TEOA (pbw on a dry | 0.01 to | 0.01 to | 0.015 to | 0.02 to |
| basis per 100 pbw | 0.2 | 0.15 | 0.12 | 0.1 |
| calcium sulfate | | | | |
| hemihydrate) | | | | |
| Additives (pbw on a | 0.1 to | 1 to | 2 to | 3 to |
| dry basis per 100 pbw | 30 | 20 | 15 | 12 |
| calcium sulfate | | | | |
| hemihydrate) | | | | |
| Weight ratio of water | 0.2:1 to | 0.3:1 to | 0.6:1 to | 0.7:1 to |
| to calcium sulfate | 1.2:1 | 1.1:1 | 1:1 | 0.95:1, for |
| hemihydrate in slurry | | | | example |
| | | | | 0.85:1 |

FIG. 2 illustrates another example of a wallboard 210 of the present invention. In this illustrated wallboard 210, the gypsum core 212 (optionally foamed) has a skim layer 214 on one face. Although not shown, a skim layer can also be on the other face. Thus, the board can have either one or two skim layers. Again, two facings 216, 218 are at the outer faces of the wallboard 210 where the first facing 216 is on the skim layer 214 and the second facing 218 is on the gypsum core 212. The compositions of TABLE 1 are also suitable a slurry for producing the skim layer 214.

For the foamed gypsum core, the slurry formulation can be foamed to have 10 to 70 volume % air, preferably 20 to 60 volume % air. The resultant foamed gypsum core has 30 to 92 volume % voids, preferably 30 to 90 volume % voids.

The calcium sulfate hemihydrate is present in the deposited aqueous slurry in amounts of at least 50 weight % of the dry (water free) materials of the aqueous slurry. Preferably the calcium sulfate hemihydrate is at least 70 weight percent of the dry (water free) materials of the aqueous slurry, more preferably at least 80 weight % of the dry (water free) materials of the aqueous slurry. In typical wallboard formulations the dry (water free) materials of the aqueous slurry has at least 90 weight percent or at least 95 weight % calcium sulfate hemihydrate. Use of calcium sulfate anhydrite is also contemplated, although it is preferably used in small amounts of less than 20 weight % of the dry (water free) materials of the aqueous slurry.

Likewise, calcium sulfate dihydrate is present in the core of the gypsum board resulting from setting the aqueous slurry is at least 50 weight % of the core, preferably at least 70 weight percent, more preferably at least 80 weight %. In typical wallboard formulations the dry (water free) materials of the aqueous slurry has at least 90 weight percent or at least 95 weight % calcium sulfate dihydrate.

The gypsum core and skim layer(s) of the gypsum wallboard of the present invention, as well as the aqueous slurries from which they are made, preferably have an absence of Portland cement.

The gypsum core and skim layer(s) of the gypsum wallboard of the present invention, as well as the aqueous slurries from which they are made, preferably have an absence of cellulosic fiber.

The gypsum core and skim layer(s) of the gypsum wallboard of the present invention, as well as the aqueous slurries from which they are made, preferably have an absence of paraffin.

The gypsum core and skim layer(s) of the gypsum wallboard of the present invention, as well as the aqueous slurries from which they are made, preferably have an absence of triethanolamine complexed with a metal.

Methods for Manufacture

Various methods can be employed for preparing a gypsum product from an aqueous gypsum slurry comprising calcium sulfate hemihydrate, at least one siloxane, siloxane polymerization catalyst, and TEOA. The siloxane dispersion, TEOA and other additives may be injected into the slurry.

In operation, a slip stream is taken from the gauging water to be used for making the aqueous gypsum slurry and combined with siloxane and water in a high shear mixer to form the siloxane emulsion. The two components are mixed for several minutes until a stabile emulsion is formed. From the high shear mixer, the emulsion goes directly to the slurry mixer where it is combined with the remainder of the gauging water.

Meanwhile, the stucco is moved toward a slurry mixer. Prior to entry into the mixer, dry additives, such as starches, or set accelerators, are added to the powdered stucco. Some additives are added directly to the mixer via a separate line. For most additives, there is no criticality regarding placing the additives in the slurry, and they may be added using whatever equipment or method is convenient.

After mixing, wallboard optionally has foam added to decrease the product density. Foam is generated by combining soap and water. The foam is then injected into the moving gypsum slurry after it exits from the mixer through a hose or chute. The foam ring is an apparatus having multiple ports that are arranged in a ring perpendicular to the axis of the hose so that foam is forced under pressure into the gypsum slurry as it passes by the foam ring.

When the foam and the slurry have been brought together, the resulting slurry moves toward and is poured onto a conveyor lined with one piece of facing material. Another piece of facing material is placed on top of the slurry, forming a sandwich with the slurry between the two facing materials. The sandwich is fed to a forming plate, the height of which determines the thickness of the board. Next the continuous sandwich is cut into appropriate lengths at the cutting knife, usually eight feet to twelve feet.

The boards are then moved to a kiln for drying. Temperatures in the kiln typically range to 450° F. to 500° F. maximum. Preferably there are three or more temperature zones in the kiln. In the first zone contacted by the wet board, the temperature increases to the maximum temperature, while the temperature slowly decreases in the last two zones. The blower for the first zone is positioned at the exit of the zone, blowing the air countercurrent to the direction of board travel. In the second and third zones, the blowers are located at the entrance to the zone, directing the hot air co-current with board travel. Heating that is less severe in the last zone prevents calcination of dry areas of the board, causing poor paper bond. A typical residence time in the kiln is about forty minutes, but the time will vary depending on the line capacity, the wetness of the board and other factors.

The two facings (back cover sheet and the front cover sheet) may be made from any suitable material having any suitable basis weight. The materials for each cover sheet may be the same or different. The two facings can be paper or a fibrous mat. Various paper grades can be used in gypsum panels, including Manila grade paper with a smooth calendared finish is often used as the facer paper cover sheet, and Newsline paper with a rougher finish is often used as the backer paper cover sheet. Typically both paper grades are multi-ply with at least one liner ply and several filler plies. However, if desired at least one paper cover sheet or both paper cover sheets are made of single-ply paper. Examples of fiber materials suitable for use in the fibrous mats include, but are not limited to, glass fibers, polyamide fibers, polyaramide fibers, polypropylene fibers, polyester fibers (e.g., polyethylene terephthalate (PET)), polyvinyl alcohol (PVOH), polyvinyl acetate (PVAc), cellulosic fibers (e.g., cotton, rayon, etc.), and combinations thereof. Furthermore, the fibers of the mat can be hydrophobic or hydrophilic, coated or uncoated.

The invention provides a method of making a gypsum board comprising:

preparing an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate:
   0.2 to 2 pbw siloxane,
   0.01 to 2 pbw siloxane polymerization catalyst comprising magnesium oxide and optionally fly ash,
0.01 to 0.2 pbw triethanolamine (TEOA);
allowing the siloxane to polymerize to polysiloxane; and
depositing the slurry on a first cover sheet and covering the slurry with a second cover sheet to shape the slurry, and
allowing the shaped slurry to set to form a set gypsum board.

The invention also provides a gypsum board comprising:

a core layer in the form of a panel, a first cover sheet and a second cover sheet, wherein the core layer is between a first cover sheet and a second cover sheet,

wherein the core layer resulted from setting, between the first cover sheet and the second cover sheet, an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate:
   0.2 to 2 pbw siloxane,
   0.01 to 2 pbw siloxane polymerization catalyst comprising magnesium oxide and optionally fly ash,
   0.01 to 0.2 pbw triethanolamine (TEOA);

in which the siloxane was allowed to polymerize to polysiloxane.

Typically the siloxane polymerization catalyst is mixed with the calcium sulfate hemihydrate, the siloxane is mixed with a first portion of the water to be used to prepare the aqueous slurry to form a siloxane/water emulsion, the siloxane/water emulsion is mixed with a second portion of the water used to prepare the aqueous slurry, and the calcium sulfate hemihydrate/magnesium oxide mixture is mixed with the siloxane emulsion, the triethanolamine and a remainder of the water for the aqueous slurry to prepare the aqueous slurry.

TEOA can be added in a number of ways. TEOA can be added to the siloxane emulsion. TEOA can be added to the gauging water. TEOA can be added before foaming the slurry, typically a few seconds (e.g., 1-10 seconds) before foaming the slurry. For example, TEOA can be added a few seconds before adding foam (also known as foam water) to the slurry to foam the slurry. TEOA can be added as part of the foam or simultaneously with the foam. Thus, for example, if the aqueous slurry (or at least the first portion of the aqueous slurry) is foamed prior to being deposited, the method may add the triethanolamine to a mixture of the siloxane emulsion, a remainder of the water for the aqueous slurry, the siloxane polymerization catalyst and the calcium sulfate hemihydrate to produce the aqueous slurry prior to this foaming.

Thus, for example the triethanolamine may be added to a mixture of the siloxane emulsion and a remainder of the water for the aqueous slurry prior to mixing with the siloxane polymerization catalyst and the calcium sulfate hemihydrate.

In the alternative for example, the triethanolamine is added to a mixture of the siloxane emulsion, the remainder of the water for the aqueous slurry, the siloxane polymerization catalyst and the calcium sulfate hemihydrate.

In the method typically a first portion of the aqueous slurry is foamed; optionally a skim layer of a second portion of the aqueous slurry is applied to a first facing, the skim layer slurry comprising water and calcium sulfate hemihydrate; the foamed first portion of the aqueous slurry is applied as a gypsum core slurry either to the first facing when the skim layer slurry is not present or to the skim layer slurry when present, the gypsum core slurry; and a second facing is applied to the gypsum core slurry.

Typically, the foamed gypsum core slurry sets to produce a foamed gypsum core having a total void volume of 30 to 90 volume percent.

Also typically, the skim layer slurry is applied and sets to produce a skim layer having a total void volume of less than 30 volume percent.

Gypsum

Gypsum is calcium sulfate dihydrate, and in the case of raw gypsum, it may also include impurities such as non-gypsum minerals, such as minor amounts of clays or other components that are associated with the gypsum source.

The calcium sulfate hemihydrate (typically provided in the raw material known as stucco or calcined gypsum) component used to form the crystalline matrix of the gypsum panel core typically comprises beta calcium sulfate hemihydrate, water-soluble calcium sulfate anhydrite, alpha calcium sulfate hemihydrate, or mixtures of any or all of these, from natural or synthetic sources. In some aspects, the stucco may include non-gypsum minerals, such as minor amounts of clays or other components that are associated with the gypsum source or are added during the calcination, processing and/or delivery of the stucco to the mixer.

The terms of art aqueous gypsum slurry or aqueous slurry or gypsum slurry are typically employed for the slurry both before and after the calcium sulfate hemihydrate converts to calcium sulfate dihydrate.

Siloxane

The present invention broadly contemplates improving the water resistance of gypsum based articles by adding a polymerizable siloxane to the slurry used to make the gypsum based articles. Preferably, the siloxane is added in the form of an emulsion. Such emulsion can, for example, comprise 1% to 20% siloxane. The slurry is then shaped and dried under conditions that promote the polymerization of the siloxane to form a highly cross-linked silicone resin. In particular, the polymerization takes place in a kiln of the gypsum board manufacturing line at temperatures in the range of 300-500° F. A catalyst that promotes the polymerization of the siloxane to form a highly cross-linked silicone resin is preferably added to the gypsum core slurry and/or the skim layer slurry.

Preferably, the siloxane is generally a fluid linear hydrogen-modified siloxane, but can also be a cyclic hydrogen-modified siloxane. Such siloxanes are capable of forming highly cross-linked silicone resins. Such fluids are well known to those of ordinary skill in the art and are commercially available and are described in the patent literature. Typically, the linear hydrogen modified siloxanes useful in the practice of the present invention comprise those having a repeating unit of the general formula:

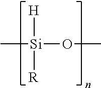

wherein R represents a saturated or unsaturated mono-valent hydrocarbon radical. In the preferred embodiments, R represents an alkyl group and most preferably R is a methyl group. During polymerization, the terminal groups are removed by condensation and siloxane groups are linked together to form the silicone resin. Cross-linking of the chains also occurs. The resulting silicone resin imparts water resistance to the gypsum matrix as it forms.

An typical siloxane is a solventless methyl hydrogen siloxane fluid.

The siloxane is formed into an emulsion or a stable suspension with water. A number of siloxane emulsions are contemplated for use in this slurry. Emulsions of siloxane in water are also available for purchase, but they may include emulsifying agents that tend to modify properties of the gypsum articles, such as the paper bond in gypsum panel products. Emulsions or stable suspensions prepared without the use of emulsifiers are therefore preferred. Preferably, the suspension will be formed in situ by mixing the siloxane fluid with water. It is essential that the siloxane suspension be stable until used and that it remains well dispersed under the conditions of the slurry. The siloxane suspension or emulsion must remain well dispersed in the presence of the optional additives, such as set accelerators, that may be present in the slurry. The siloxane suspension or emulsion must also remain stable through the steps in which the gypsum panels are formed as well. Preferably, the suspension remains stable for more than 40 minutes. More preferably, it remains stable for at least one hour. As used herein, the term “emulsion” is intended to include true emulsions and suspensions that are stable at least until the calcium sulfate hemihydrate is 50% set.

Preferably, the siloxane/water emulsion is formed in a high-intensity mixer and immediately mixed with water for the aqueous slurry for a few, e.g., 1-2 seconds, to form the oil in water siloxane emulsion. Typically the siloxane in water is about 1-25 wt %, preferably 3-10 wt %, of the siloxane/water emulsion.

The siloxane can be present in the gypsum core slurry and/or the skim layer slurry at a concentration on a dry basis per 100 pbw of calcium sulfate hemihydrate of about 0.2 to about 2 pbw; preferably about 0.25 to about 1.5 pbw; more preferably about 0.3 to about 1.2 pbw; and most preferably about 0.4 to about 1.0 pbw.

Catalyst

The siloxane polymerization reaction proceeds slowly on its own, requiring that the panels be stored for a time sufficient to develop water-resistance prior to shipping. Catalysts are known to accelerate the polymerization reaction, reducing or eliminating the time needed to store gypsum panels as the water-resistance develops.

The catalysts comprise magnesium oxide and optionally fly ash. Use of dead-burned magnesium oxide for siloxane polymerization is described in U.S. Pat. No. 7,892,472, entitled “Method of Making Water-Resistant Gypsum-Based Article”, herein incorporated by reference. Dead-burned magnesium oxide is water-insoluble and interacts less with other components of the slurry. It acts as a catalyst to accelerate curing of the siloxane and, in some cases, causes the siloxane to cure more completely. It is commercially available with a consistent composition. A typical source of dead-burned magnesium oxide a BET surface area of at least 0.3 m²/g. The loss on ignition is less than 0.1% by weight.

There are at least three grades of magnesium oxide on the market, depending on the calcination temperature. “Dead-burned” magnesium oxide is calcined between 1500° C. and 2000° C., eliminating most, if not all, of the reactivity. “Hard-burned” magnesium oxide is calcined at temperatures from 1000° C. to about 1500° C. It has a narrow range of reactivity, a high density, and is normally used in application where slow degradation or chemical reactivity is required, such as in animal feed and fertilizer. The third grade is “light-burn” or “caustic” magnesia, produced by calcining at temperatures of about 700° C. to about 1000° C. This type of magnesia is used in a wide range of applications, including plastics, rubber, paper and pulp processing, steel boiler additives, adhesives and acid neutralization.

If desired catalysts are made of a mixture of magnesium oxide and fly ash, preferably a mixture of magnesium oxide and Class C fly ash. When combined in this manner, any of the grades of magnesium oxide are useful. However, dead-burned and hard-burned magnesium oxides are preferred due to reduced reactivity. The relatively high reactivity of magnesium oxides, can lead to cracking reactions which can produce hydrogen. As the hydrogen is generated, the product expands, causing cracks where the calcium sulfate hemihydrate has set. Expansion also causes breakdown of molds into which the calcium sulfate hemihydrate is poured, resulting in loss of detail and deformation of the product in one or more dimensions. Preferably, the magnesium oxide and fly ash are added to the calcium sulfate hemihydrate prior to their addition to the gauging water. Dry components such as these are often added to the calcium sulfate hemihydrate as it moves along a conveyer to the mixer.

Class C hydraulic fly ash, or its equivalent, is the most preferred fly ash component. A typical composition of a Class C fly ash is shown in Table 1. High lime content fly ash, greater than 20% lime by weight, which is obtained from the processing of certain coals. ASTM designation C-618, herein incorporated by reference, describes the characteristics of Class C fly ash.

Catalysis of the siloxane polymerization results in faster and more complete polymerization and cross-linking of siloxane to form the silicone resin. Hydration of the calcium sulfate hemihydrate forms an interlocking matrix of calcium sulfate dihydrate crystals. While the gypsum matrix is forming, the siloxane molecules are also forming a silicone resin matrix. Since these are formed simultaneously, at least in part, the two matrices become intertwined in each other. Excess water and additives to the slurry, including the fly ash (if any), magnesium oxide and additives described below, which were dispersed throughout the aqueous slurry, become dispersed throughout the matrices in the interstitial spaces to achieve water resistance throughout the panel core.

Per 100 pbw of calcium sulfate hemihydrate the catalyst can be present in the gypsum core slurry and/or the skim layer slurry at a concentration on a dry basis of about 0.01 to about 2 pbw; preferably about 0.05 to about 1 pbw; more preferably about 0.1 to about 0.8 pbw; and most preferably about 0.15 to about 0.4 pbw.

Triethanolamine (TEOA)

Without being limited by theory, it is believed that TEOA acts in combination with the catalyst (MgO and optionally fly ash) to shorten the polymerization time of the siloxane and increase the amount of siloxane that is polymerized.

TEOA has the following formula (I):

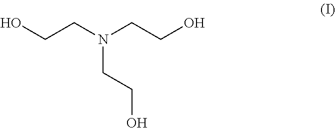

This differs from triethyl amine. Indeed, the gypsum slurry of the core layer and, if present, the skim layer, may have an absence of triethyl amine.

Also, the TEOA is not complexed with a metal. For example, TEOA used in the present invention does not encompass a triethanolamine titanium complex. Thus, there may preferably be an absence of triethanolamine titanium complex.

The TEOA can be present in the gypsum core slurry and/or the skim layer slurry at a concentration of about 0.01 to about 0.2 pbw on a dry basis per 100 pbw of calcium sulfate hemihydrate; preferably, about 0.01 to about 0.15 pbw on a dry basis per 100 pbw of calcium sulfate hemihydrate; more preferably, about 0.015 to about 0.12 pbw on a dry basis per 100 pbw of calcium sulfate hemihydrate; and most preferably, about 0.02 to about 0.1 pbw on a dry basis per 100 pbw of calcium sulfate hemihydrate.

Additives

Optional additives include, but are not limited to any one or more of: starches, dispersants, phosphate-containing component, accelerators, retarders, glass fibers, dehydration inhibitors, binders, adhesives, dispersing aids, thickeners, bactericides, fungicides, pH adjusters, colorants, fillers, and mixtures thereof.

Additives cumulatively can be present in the gypsum core slurry and/or the skim layer slurry at a total concentration in pbw on a dry basis (water free) per 100 pbw of calcium sulfate hemihydrate of about 0.1 to about 30 pbw; preferably about 1 to about 20 pbw; more preferably about 2 to about 15 pbw; and most preferably about 3 to about 12 pbw.

Starches, including pregelatinized starch in particular, can optionally be used in the methods and composition of the present invention. A preferred starch is pregelatinized starch, especially pregelatinized corn starch. For example, pregelatinized corn flour is available from Bunge Milling having the following typical analysis: moisture 7.5%, protein 8.0%, oil 0.5%, crude fiber 0.5%, ash 0.3%; having a green strength of 0.48 psi; and having a loose bulk density of 35.0 lb/ft³.

Starches, when included, can be present in the gypsum core slurry and/or the skim layer slurry in amounts on a dry basis per 100 pbw of calcium sulfate hemihydrate of about 0.5 to about 30 pbw; preferably about 1 to about 20 pbw; more preferably about 2 to about 15 pbw; and most preferably about 3 to about 12 pbw.

Fibers can optionally be used in the methods and composition of the present invention. The fibers may include mineral fibers (also known as mineral wool), glass fibers, carbon fibers, and mixtures of such fibers, as well as other comparable fibers providing comparable benefits to the wallboard. For example, glass fibers can be incorporated in the gypsum core slurry and/or the skim layer slurry and resulting crystalline core structure. The glass fibers in such aspects may have an average length of about 0.5 to about 0.75 inches and a diameter of about 11 to about 17 microns. In other aspects, such glass fibers may have an average length of about 0.5 to about 0.675 inches and a diameter of about 13 to about 16 microns. In yet other aspects, E-glass fibers are utilized having a softening point above about 800° C. or above at least about 900° C. Mineral wool or carbon fibers such as those know to those of ordinary skill may be used in place of or in combination with glass fibers.

Fibers, when included, can be present in the gypsum core slurry and/or the skim layer slurry in amounts on a dry basis per 100 pbw of calcium sulfate hemihydrate of about 0.5 to about 10 pbw; preferably about 1 to about 8 pbw; more preferably about 2 to about 7 pbw; and most preferably about 3 to about 6 pbw.

Optionally, a phosphate-containing component comprising a phosphate salt or other source of phosphate ions can be added to the gypsum core slurry and/or the skim layer slurry. The use of such phosphates contributes to providing the set gypsum with increased strength, resistance to permanent deformation (e.g., sag resistance), dimensional stability, and increased strength of the panels when in a wet state, compared with set gypsum formed from a mixture containing no phosphate. The phosphate source is added in amounts to provide dimensional stability to the wallboard while the gypsum hemihydrate in the core hydrates and forms the gypsum dihydrate crystalline core structure. Additionally, it is noted that to the extent that the added phosphate acts as a retarder, an appropriate accelerator can be added at the required level to overcome any adverse retarding effects of the phosphate.

The phosphate-containing components useful in the present invention are water-soluble and are in the form of an ion, a salt, or an acid, namely, condensed phosphoric acids, each of which comprises 2 or more phosphoric acid units; salts or ions of condensed phosphates, each of which comprises 2 or more phosphate units; and monobasic salts or monovalent ions of orthophosphates, such as described, for example, in U.S. Pat. Nos. 6,342,284; 6,632,550; and 6,815,049, the disclosures of all of which are incorporated herein by reference. Suitable examples of such classes of phosphates will be apparent to those skilled in the art. For example, any suitable monobasic orthophosphate-containing compound can be utilized in the practice of the invention, including, but not limited to, monoammonium phosphate, monosodium phosphate, monopotassium phosphate, and combinations thereof. A preferred monobasic phosphate salt is monopotassium phosphate.

Similarly, any suitable water-soluble polyphosphate salt can be used in accordance with the present invention. The polyphosphate can be cyclic or acyclic. Exemplary cyclic polyphosphates include, for example, trimetaphosphate salts and tetrametaphosphate salts. The trimetaphosphate salt can be selected, for example, from sodium trimetaphosphate (also referred to herein as STMP), potassium trimetaphosphate, lithium trimetaphosphate, ammonium trimetaphosphate, and the like, or combinations thereof.

Also, any suitable polyphosphate salt can be utilized in accordance with the present invention. The polyphosphate salt has at least two phosphate units. By way of example, suitable polyphosphate salts in accordance with the present invention include, but are not limited to, pyrophosphates, trimetaphosphates, sodium hexametaphosphate having from about 6 to about 27 repeating phosphate units, potassium hexametaphosphate having from about 6 to about 27 repeating phosphate units, ammonium hexametaphosphate having from about 6 to about 27 repeating phosphate units, and combinations thereof. A preferred polyphosphate salt for use in the present invention is a sodium trimetaphosphate (STMP).

Preferably, the phosphate-containing compound is selected from the group consisting of sodium trimetaphosphate having the molecular formula (NaPO₃)₃, sodium hexametaphosphate having 6-27 repeating phosphate units and having the molecular formula Naₙ₊₂PₙO³ⁿ⁺¹ wherein n=6-27, tetrapotassium pyrophosphate having the molecular formula K₄P₂O₇, trisodium dipotassium tripolyphosphate having the molecular formula Na₃K₂P₃O₁₀, sodium tripolyphosphate having the molecular formula Na₅P₃O₁₀, tetrasodium pyrophosphate having the molecular formula Na₄P₂O₇, aluminum trimetaphosphate having the molecular formula Al(PO₃)₃, sodium acid pyrophosphate having the molecular formula Na₂H₂P₂O₇, ammonium polyphosphate having 1000-3000 repeating phosphate units and having the molecular formula (NH₄)ₙ₊₂PₙO₃ₙ₊₁ wherein n=1000-3000, and polyphosphoric acid having 2 or more repeating phosphoric acid units and having the molecular formula Hₙ₊₂PₙO₃ₙ₊₁ wherein n is 2 or more.

The phosphates usually are added in a dry form and/or an aqueous solution liquid form, with the dry ingredients added to the slurry mixer, with the liquid ingredients added to the mixer, or in other stages or procedures.

Phosphate-containing components, when included, can be present in the gypsum core slurry and/or the skim layer slurry in amounts on a dry basis per 100 pbw of calcium sulfate hemihydrate of about 0.01 to about 1 pbw; preferably about 0.02 to about 0.8 pbw; more preferably about 0.03 to about 0.7 pbw; and most preferably about 0.04 to about 0.4 pbw.

Dispersants may optionally be included in the gypsum core slurry and/or the skim layer slurry. The dispersants may be added in a dry form with other dry ingredients and/or an aqueous solution liquid form with other liquid ingredients in the core slurry mixing operation, or in other steps or procedures.

Examples of dispersants may include, but are not limited to, naphthalene sulfonates, such as polynaphthalenesulfonic acid and its salts (polynaphthalenesulfonates) and derivatives, which are condensation products of naphthalene sulfonic acids and formaldehyde. Such desirable polynaphthalenesulfonates include sodium and calcium naphthalene sulfonate. The average molecular weight of the naphthalene sulfonates can range from about 3,000 to 27,000, although it is preferred that the molecular weight be about 8,000 to 10,000. At a given solids percentage aqueous solution, a higher molecular weight dispersant has higher viscosity, and generates a higher water demand in the formulation, than a lower molecular weight dispersant.

The naphthalene sulfonates are preferably used as aqueous solutions in the range 35-55% by weight solids content, for example. It is most preferred to use the naphthalene sulfonates in the form of an aqueous solution, for example, in the range of about 40-45% by weight solids content. Alternatively, where appropriate, the naphthalene sulfonates can be used in dry solid or powder form.

Alternatively, in other aspects of the invention, polycarboxylate dispersants useful for improving fluidity in gypsum core slurry and/or the skim layer slurry may be used. A number of polycarboxylate dispersants, particularly polycarboxylic ethers, are preferred types of dispersants. One of the preferred classes of dispersants used in the slurry includes two repeating units. It is described further in U.S. Pat. No. 7,767,019, entitled “Gypsum Products Utilizing a Two-Repeating Unit System and Process for Making Them,” which is incorporated by reference. Typical dispersants are described more fully in U.S. Patent App. Pub. No. U.S. 2007/0255032A1, herein incorporated by reference.

The molecular weight of one type of such polycarboxylate dispersant may be from about 20,000 to about 60,000 Daltons. It has been found that the lower molecular weight dispersants cause less retardation of set time than dispersants having a molecular weight greater than 60,000 Daltons. Generally longer side chain length, which results in an increase in overall molecular weight, provides better dispensability. However, tests with gypsum indicate that efficacy of the dispersant is reduced at molecular weights above 50,000 Daltons.

Another class of polycarboxylate compounds that are useful as dispersants in this invention is disclosed in U.S. Pat. No. 6,777,517, herein incorporated by reference.

Yet another polycarboxylic ether dispersant family is more fully described in U.S. Pat. No. 5,798,425, herein incorporated by reference. Other dispersants that can be used include lignosulfonates, or sulfonated lignin. Lignosulfonates are water-soluble anionic polyelectrolyte polymers, byproducts from the production of wood pulp using sulfite pulping.

Dispersants, when included, can be present in the gypsum core slurry and/or the skim layer slurry in amounts on a dry basis per 100 pbw of calcium sulfate hemihydrate of about 0.01 to about 2 pbw; preferably about 0.05 to about 1.5 pbw; more preferably about 0.1 to about 1.0 pbw; and most preferably about 0.2 to about 0.8 pbw.

Set retarders or dry accelerators may optionally be added to the gypsum core slurry and/or the skim layer slurry to modify the rate at which the calcium sulfate hemihydrate hydration reactions take place. “CSA” is a set accelerator including 95% calcium sulfate dihydrate co-ground with 5% sugar and heated to 250° F. (121° C.) to caramelize the sugar. CSA is available from USG Corporation and is made according to U.S. Pat. No. 3,573,947, herein incorporated by reference. Potassium sulfate is another preferred accelerator. HRA, (Heat Resistant Accelerator) which is a preferred accelerator, is calcium sulfate dihydrate freshly ground with sugar at a ratio of about 5 to 25 pounds of sugar per 100 pounds of calcium sulfate dihydrate. It is further described in U.S. Pat. No. 2,078,199, herein incorporated by reference. Both of these are preferred accelerators.

Another accelerator, known as wet gypsum accelerator or WGA, is also a preferred accelerator. A description of the use of and a method for making wet gypsum accelerator are disclosed in U.S. Pat. No. 6,409,825, herein incorporated by reference. This accelerator includes at least one additive selected from the group consisting of an organic phosphonic compound, a phosphate-containing compound or mixtures thereof. This particular accelerator exhibits substantial longevity and maintains its effectiveness over time such that the wet gypsum accelerator can be made, stored, and even transported over long distances prior to use.

Accelerator and/or retardent, when included, can be present in the gypsum core slurry and/or the skim layer slurry in amounts on a dry basis per 100 pbw of calcium sulfate hemihydrate of about 0.01 to about 5 pbw; preferably about 0.05 to about 3.0 pbw; more preferably about 0.08 to about 2.0 pbw; and most preferably about 0.08 to about 1 pbw.

Foam may optionally be introduced into the gypsum core slurry and/or the skim layer slurry (preferably the gypsum core slurry) in amounts that provide the above mentioned reduced core density and panel weight. The introduction of foam in the gypsum core slurry in the proper amounts, formulations, and process will produce a desired network and distribution of voids within the core of the final dried wallboards. This void structure permits the reduction of the gypsum and other core constituents and the core density and weight, while maintaining desired panel structural and strength properties. Examples of the use of foaming agents to produce desired void structures include those discussed in U.S. Pat. No. 5,643,510, the disclosure of which is incorporated by reference herein. The approaches for adding foam to a gypsum core slurry are known in the art and one example of such an approach is discussed in U.S. Pat. No. 5,683,635, the disclosure of which is incorporated by reference herein.

Water

Water is added to the slurry in any amount that makes a flowable slurry. The amount of water to be used varies greatly according to the application with which it is being used, the exact dispersant being used, the properties of the calcium sulfate hemihydrate, and the additives being used.

Water used to make the slurry should be as pure as practical for best control of the properties of both the slurry and the set plaster. Salts and organic compounds are well known to modify the set time of the slurry, varying widely from accelerators to set inhibitors. Some impurities lead to irregularities in the structure as the interlocking matrix of dihydrate crystals forms, reducing the strength of the set product. Product strength and consistency is thus enhanced by the use of water that is as contaminant-free as practical.

The water can be present in the gypsum core slurry and/or the skim layer slurry at a weight ratio of water to calcium sulfate hemihydrate of about 0.2:1 to about 1.2:1; preferably, about 0.3:1 to about 1.1:1; more preferably, about 0.6:1 to about 1:1; most preferably 0.7:1 to 0.95:1; and typically about 0.85:1.

Clauses of Various Characteristics of Methods and Products of the Invention

While not limiting the invention the following provides additional disclosure relating to aspect of the invention.

Clause 1. A method of making a gypsum board comprising:
preparing an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate: 0.2 to 2 pbw siloxane,
0.01 to 2 pbw siloxane polymerization catalyst comprising magnesium oxide and optionally fly ash, and
0.01 to 0.2 pbw triethanolamine (TEOA);
allowing the siloxane to polymerize to polysiloxane; and
depositing the slurry on a first cover sheet and covering the slurry with a second cover sheet to shape the slurry, and
allowing the shaped slurry to set to form a set gypsum board.

Clause 2. The method of clause 1,
wherein the siloxane polymerization catalyst is mixed with the calcium sulfate hemihydrate,
wherein the siloxane is mixed with a first portion of the water to be used to prepare the aqueous slurry to form a siloxane/water emulsion,
wherein the siloxane/water emulsion is mixed with a second portion of the water used to prepare the aqueous slurry, and
wherein the calcium sulfate hemihydrate/magnesium oxide mixture is mixed with the siloxane emulsion, the triethanolamine and a remainder of the water for the aqueous slurry to prepare the aqueous slurry.

Clause 3. The method of clause 2, wherein the triethanolamine is added to a mixture of the siloxane emulsion and a remainder of the water for the aqueous slurry prior to mixing with the siloxane polymerization catalyst and the calcium sulfate hemihydrate.

Clause 4. The method of clause 2, wherein the triethanolamine is added to a mixture of the siloxane emulsion, a remainder of the water for the aqueous slurry, the siloxane polymerization catalyst and the calcium sulfate hemihydrate.

Clause 5. The method of clause 1,
wherein a first portion of the aqueous slurry is foamed;
optionally a skim layer of a second portion of the aqueous slurry is applied to a first facing;
wherein the foamed first portion of the aqueous slurry is applied as a gypsum core slurry either to the first facing when the skim layer slurry is not present or to the skim layer slurry when present, the gypsum core slurry; and wherein a second facing is applied to the gypsum core slurry.

Clause 6. The method of clause 5, wherein the triethanolamine is added to a mixture of the siloxane emulsion, a remainder of the water for the aqueous slurry, the siloxane polymerization catalyst and the calcium sulfate hemihydrate to produce the aqueous slurry prior to foaming the first portion of the aqueous slurry.

Clause 7. The method of clause 5, wherein the triethanolamine is added to a mixture of the siloxane emulsion, a remainder of the water for the aqueous slurry, the siloxane polymerization catalyst and the calcium sulfate hemihydrate to produce the aqueous slurry while foaming the first portion of the aqueous slurry.

Clause 8. The method of clause 5, wherein the triethanolamine together with foam water for foaming the first portion of the aqueous slurry is added to a mixture of the siloxane emulsion, a remainder of the water for the aqueous slurry, the siloxane polymerization catalyst and the calcium sulfate hemihydrate.

Clause 9. The method of clause 5, wherein the foamed gypsum core slurry sets to produce a foamed gypsum core having a total void volume of 30 to 90 volume percent.

Clause 10. The method of clause 5, wherein the skim layer slurry is applied and sets to produce a skim layer having a total void volume of less than 30 volume percent.

Clause 11. The method of clause 1, wherein the gypsum core slurry has an absence of triethanolamine complexed with a metal.

Clause 12. The method of any preceding clause, wherein the gypsum core slurry has an absence of Portland cement.

Clause 13. The method of any preceding clause, wherein the siloxane comprises a fluid linear hydrogen-modified siloxane, a cyclic hydrogen-modified siloxane, or a mixture thereof.

Clause 14. The method of any preceding clause, wherein the slurry further comprises one or more additives at 1 to 8 pbw on a dry basis per 100 pbw calcium sulfate hemihydrate, the additives comprising one or more of starches, dispersants, phosphate-containing component, accelerators, retarders, glass fibers, dehydration inhibitors, binders, adhesives, dispersing aids, thickeners, bactericides, fungicides, pH adjusters, colorants, fillers, and mixtures thereof.

Clause 15. The method of any preceding clause, wherein the first facing and/or the second facing comprises glass fibers, polyamide fibers, polyaramide fibers, polypropylene fibers, polyester fibers, polyvinyl alcohol (PVOH), polyvinyl acetate (PVAc), cellulosic fibers, or combinations thereof.

Clause 16. The method of any preceding clause, wherein the gypsum core slurry comprises on a dry basis per 100 pbw calcium sulfate hemihydrate:

0.25 to 1.5 pbw said siloxane,
0.05 to 1 pbw said catalyst,
0.01 to 0.15 pbw said TEOA, and
wherein the weight ratio of water to calcium sulfate hemihydrate is 0.3:1 to 1.1:1.

Clause 17. The method of any preceding clause, wherein the gypsum core slurry comprises on a dry basis per 100 pbw calcium sulfate hemihydrate:
0.4 to 1.0 pbw said siloxane,
0.15 to 0.4 pbw said catalyst,
0.02 to 0.1 pbw said TEOA, and
wherein the weight ratio of water to calcium sulfate hemihydrate is 0.7:1 to 0.95:1.

Clause 18. The method of any preceding clause, wherein the catalyst comprises the fly ash.

Clause 19. A gypsum board comprising:
a core layer in the form of a panel, a first cover sheet and a second cover sheet, wherein the core layer is between a first cover sheet and a second cover sheet, wherein the core layer resulted from setting, between the first cover sheet and the second cover sheet, an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate: 0.2 to 2 pbw siloxane,
0.01 to 2 pbw siloxane polymerization catalyst comprising magnesium oxide and optionally fly ash, and
0.01 to 0.2 pbw triethanolamine (TEOA);
in which the siloxane was allowed to polymerize to polysiloxane.

Clause 20. The gypsum board of clauses 18, further comprising:

a first facing and a second facing,
wherein the gypsum core is between the first facing and the second facing.

Clause 21. The gypsum board of clauses 18, further comprising a skim layer, wherein the structure of the wallboard is layered, in order, the first facing, the skim layer, the gypsum core, and the second facing.

Clause 22. The gypsum board of one of clauses 19-21, wherein the gypsum core slurry has an absence of triethanolamine complexed with a metal.

Clause 23. The gypsum board of one of clauses 19-22, wherein the gypsum core slurry has an absence of Portland cement.

Clause 24. The gypsum board of one of clauses 19-23, wherein the gypsum core is foamed.

Clause 25. The gypsum board of one of clauses 19-24, wherein the catalyst comprises the fly ash.

Clause 26. The gypsum board of any of clauses 19-25, wherein the first facing and/or the second facing comprises glass fibers, polyamide fibers, polyaramide fibers, polypropylene fibers, polyester fibers, polyvinyl alcohol (PVOH), polyvinyl acetate (PVAc), cellulosic fibers, or combinations thereof.

Clause 27. The gypsum board of any of clauses 19-26, wherein the gypsum core slurry comprises on a dry basis per 100 pbw calcium sulfate hemihydrate:
0.25 to 1.5 pbw said siloxane,
0.05 to 1 pbw said catalyst,
0.01 to 0.15 pbw said TEOA, and
wherein the weight ratio of water to calcium sulfate hemihydrate is 0.3:1 to 1.1:1.

Clause 28. The gypsum board of one of clauses 19-27, wherein the gypsum core slurry comprises on a dry basis per 100 pbw calcium sulfate hemihydrate: 0.4 to 1.0 pbw said siloxane,
0.15 to 0.4 pbw said catalyst,
0.02 to 0.1 pbw said TEOA, and
wherein the weight ratio of water to calcium sulfate hemihydrate is 0.7:1 to 0.95:1.

Clause 29. A gypsum board made by the method of any of clauses 1-18, comprising:

a core layer in the form of a panel, a first cover sheet and a second cover sheet, wherein the core layer is between a first cover sheet and a second cover sheet,

wherein the core layer resulted from setting, between the first cover sheet and the second cover sheet, the aqueous slurry.

Clause 30. A gypsum board comprising:

a core layer in the form of a panel, a first cover sheet and a second cover sheet,

wherein the core layer is between a first cover sheet and a second cover sheet,

wherein the core layer resulted from setting, between the first cover sheet and

the second cover sheet, an aqueous slurry of any of clauses 1-18.

### EXAMPLES

In the examples herein, as mentioned above, percentages of compositions or product formulae are in weight percentages, unless otherwise expressly stated. The reported measurements also in approximate amounts unless expressly stated, for example, approximate percentages, weights, temperatures, distances or other properties.

Seven samples were prepared according to the formulations in TABLE 2. Samples 1 and 2 are controls with no TEOA.

TABLE 2
Sample Formulations

| | Sample Nos. | | | | | | |
|---|---|---|---|---|---|---|---|
| Component | 1 | 2 | 3 | 4 | 5 | 6 | 7 |
| Calcium sulfate hemihydrate | 100 | 100 | 100 | 100 | 100 | 100 | 100 |
| HRA* | 0.875 | 0.875 | 0.875 | 0.875 | 0.875 | 0.875 | 0.875 |
| Starch** | 1.575 | 1.575 | 1.575 | 1.575 | 1.575 | 1.575 | 1.575 |
| MgO** | 0.245 | 0.245 | 0.245 | 0.245 | 0.245 | 0.245 | 0.245 |
| TEOA** | — | — | 0.0275 | 0.055 | — | — | — |
| 1% TEOA Solution*** | — | — | — | — | 2.75 (0.0275) | 5.5 (0.055) | 5.5 (0.055) |
| 10% Sodium | 1.575 (0.157) | 1.575 (0.157) | 1.575 (0.157) | 1.575 (0.1575) | 1.575 (0.1575) | 1.575 (0.1575) | 1.575 (0.1575) |
| Trimetaphosphate Solution*** | | | | | | | |
| Retarder (1%)* | 2.5 | 2.5 | 2.5 | 2.5 | 2.5 | 2.5 | 1.25 |
| Dispersant** | 0.15 | 0.5 | 0.5 | 0.5 | 0.5 | 0.5 | 0.5 |
| 5% Siloxane Solution*** | 19.7 (0.98) | 11.8 (0.59) | 11.8 (0.59) | 11.8 (0.59) | 11.8 (0.59) | 11.8 (0.59) | 9.8 (0.49) |
| Water (pbw) | 73 | 80 | 80 | 80 | 77 | 75 | 78 |

*Heat resistant accelerator (HRA) which is a gypsum setting accelerator, not a siloxane polymerization accelerator, parts by weight on a dry basis per 100 parts calcium sulfate hemihydrate.
**Parts by weight on a dry (water free) basis per 100 parts calcium sulfate hemihydrate.
***Parts by weight of solution per 100 parts calcium sulfate hemihydrate, value in parenthesis is parts by weight (pbw) active component on a dry (water free) basis per 100 parts by weight calcium sulfate hemihydrate.

The slurries were cast into a 2 inch×2 inch×2 inch cube mold. The siloxane was allowed to polymerize and the calcium sulfate hemihydrate allowed to set. A 5 wt % siloxane emulsion was prepared by mixing siloxane and water in a high shear mixer at a rate of 7500 rpm for 2.5 minutes. The 5 wt % siloxane emulsion and other liquid additives were added to water and put into a Hobart Mixer as a liquid mixture. The slurry was prepared by soaking the dry powders in the liquid mixture in the mixer for 10 seconds and then mixing for 10 seconds, followed by injecting the foam for 9 seconds and mixing another 2 seconds. The TEOA was added before injecting the foam. The cubes were cast at room temperature. The cubes were then placed in a drying oven and dried at 110° F. overnight until the weight of the cube was unchanged meaning the water had fully reacted or evaporated.

The dried cubes where soaked in water for 2 hours for the water absorption test as specified in ASTM C1396-17. TABLE 3 shows water absorption in weight percent for these cubes.

TABLE 3
Water Absorption (wt. %)
Cube Sample Nos.

| 1 (Control) | 2 (Control) | 3 | 4 | 5 | 6 | 7 |
|---|---|---|---|---|---|---|
| 6.04 wt % | 6.95 wt % | 5.8 wt % | 5.2 wt % | 5.8 wt % | 4.6 wt % | 5.3 wt % |

Control Samples 1 and 2 (without TEOA) absorbed the most water. Further, TEOA can be used in the slurry formulation from diluted or non-diluted and still enhance the water resistance performance of the final set product.

While particular versions of the invention have been shown and described, it will be appreciated by those skilled in the art that changes and modifications may be made thereto without departing from the invention in its broader aspects and as set forth in the following claims.

What is claimed is:

1. A method of making a gypsum board comprising:
preparing an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate:
0.2 to 2 pbw siloxane,
0.01 to 2 pbw siloxane polymerization catalyst comprising magnesium oxide and optionally fly ash, and
0.01 to 0.2 pbw triethanolamine (TEOA);
allowing the siloxane to polymerize to polysiloxane; and
depositing the slurry on a first cover sheet and covering the slurry with a second cover sheet to shape the slurry, and
allowing the shaped slurry to set to form the gypsum board.

2. The method of claim 1,
wherein the siloxane polymerization catalyst is mixed with the calcium sulfate hemihydrate,
wherein the siloxane is mixed with a first portion of the water to be used to prepare the aqueous slurry to form a siloxane/water emulsion,
wherein the siloxane/water emulsion is mixed with a second portion of the water used to prepare the aqueous slurry, and
wherein the calcium sulfate hemihydrate/magnesium oxide mixture is mixed with the siloxane emulsion, the triethanolamine and a remainder of the water for the aqueous slurry to prepare the aqueous slurry.

3. The method of claim 1,
wherein a first portion of the aqueous slurry is foamed;
optionally a skim layer of a second portion of the aqueous slurry is applied to a first facing;
wherein the foamed first portion of the aqueous slurry is applied as a gypsum core slurry either to the first facing when the skim layer slurry is not present or to the skim layer slurry when present, the gypsum core slurry; and
wherein a second facing is applied to the gypsum core slurry.

4. The method of claim 3, wherein the foamed gypsum core slurry sets to produce a foamed gypsum core having a total void volume of 30 to 90 volume percent.

5. The method of claim 1, wherein the gypsum core slurry has an absence of triethanolamine complexed with a metal.

6. The method of claim 1, wherein the gypsum core slurry has an absence of Portland cement.

7. The method of claim 1, wherein the slurry further comprises one or more additives at 1 to 8 pbw on a dry basis per 100 pbw calcium sulfate hemihydrate, the additives comprising one or more of starches, dispersants, phosphate-containing component, accelerators, retarders, glass fibers, dehydration inhibitors, binders, adhesives, dispersing aids, thickeners, bactericides, fungicides, pH adjusters, colorants, fillers, and mixtures thereof.

8. The method of claim 1, wherein the gypsum core slurry comprises on a dry basis per 100 pbw calcium sulfate hemihydrate:
0.25 to 1.5 pbw said siloxane,
0.05 to 1 pbw said catalyst,
0.01 to 0.15 pbw said TEOA, and
wherein the weight ratio of water to calcium sulfate hemihydrate is 0.3:1 to 1.1:1.

9. The method of claim 1, wherein the gypsum core slurry comprises on a dry basis per 100 pbw calcium sulfate hemihydrate:
0.4 to 1.0 pbw said siloxane,
0.15 to 0.4 pbw said catalyst,
0.02 to 0.1 pbw said TEOA, and
wherein the weight ratio of water to calcium sulfate hemihydrate is 0.7:1 to 0.95:1.

10. The method of claim 1, wherein the catalyst comprises the magnesium oxide.

11. A gypsum board comprising:
a core layer in the form of a panel, a first cover sheet and a second cover sheet, wherein the core layer is between a first cover sheet and a second cover sheet,
wherein the core layer resulted from setting, between the first cover sheet and the second cover sheet, an aqueous slurry comprising a mixture of:
calcium sulfate hemihydrate,
water at a weight ratio of water to calcium sulfate hemihydrate of 0.2:1 to 1.2:1, and
on a dry basis per 100 parts by weight (pbw) said calcium sulfate hemihydrate:
0.2 to 2 pbw siloxane,
0.01 to 2 pbw siloxane polymerization catalyst comprising magnesium oxide and optionally fly ash, and
0.01 to 0.2 pbw triethanolamine (TEOA);
in which the siloxane was allowed to polymerize to polysiloxane.

12. The gypsum board of claim 11, further comprising:
a first facing and a second facing,
wherein the gypsum core is between the first facing and the second facing.

13. The gypsum board of claim 12, further comprising a skim layer, wherein the structure of the wallboard is layered, in order, the first facing, the skim layer, the gypsum core, and the second facing.

14. The gypsum board of claim 11, wherein the gypsum core slurry has an absence of triethanolamine complexed with a metal.

15. The gypsum board of claim 11, wherein the gypsum core slurry has an absence of Portland cement.

16. The gypsum board of claim 11, wherein the catalyst comprises the fly ash.

17. The gypsum board of claim 11, wherein the first facing and/or the second facing comprises glass fibers, polyamide fibers, polyaramide fibers, polypropylene fibers, polyester fibers, polyvinyl alcohol (PVOH), polyvinyl acetate (PVAc), cellulosic fibers, or combinations thereof.

18. The gypsum board of claim 11, wherein the gypsum core slurry comprises on a dry basis per 100 pbw calcium sulfate hemihydrate:
0.25 to 1.5 pbw said siloxane,
0.05 to 1 pbw said catalyst,
0.01 to 0.15 pbw said TEOA, and
wherein the weight ratio of water to calcium sulfate hemihydrate is 0.3:1 to 1.1:1.

19. A gypsum board made by the method of claim 1, comprising:
a core layer in the form of a panel, a first cover sheet and a second cover sheet, wherein the core layer is between a first cover sheet and a second cover sheet,
wherein the core layer resulted from setting, between the first cover sheet and the second cover sheet, the aqueous slurry.

20. A gypsum board comprising:
a core layer in the form of a panel, a first cover sheet and a second cover sheet, wherein the core layer is between a first cover sheet and a second cover sheet,
wherein the core layer resulted from setting, between the first cover sheet and the second cover sheet, an aqueous slurry of claim 1.
